(19) United States
(12) Patent Application Publication
(10) Pub. No.: US 2015/0366222 A1
(43) Pub. Date: Dec. 24, 2015

(54) FEEDER DEVICE FOR FEEDING A FOOD PRODUCT IN A MACHINE FOR MAKING FILLED PASTA AND MACHINE FOR MAKING FILLED PASTA COMPRISING SUCH A FEEDER DEVICE

(71) Applicant: G.D S.P.A., Bologna (IT)

(72) Inventors: Ivanoe BERTUZZI, Casalecchio di Reno (Bologna) (IT); Umberto ZANETTI, Modena (IT); Andrea BIONDI, Bologna (IT)

(21) Appl. No.: 14/762,358

(22) PCT Filed: Jan. 14, 2014
(86) PCT No.: PCT/IB2014/058254

§ 371 Date: Jul. 21, 2015

(30) Foreign Application Priority Data
Jan. 23, 2013 (IT) BO2013A000028

(51) Int. Cl. A21C 9/06

(52) U.S. Cl. CPC A21C 9/06

(57) ABSTRACT

A machine for making filled pasta comprises at least one station for preparing a strip of pasta sheet; a station for preparing a filling; a filling operation station, in communication with the station for preparing the strip of pasta sheet and with the station for preparing the filling, in which portions of filling are wrapped in corresponding portions of the strip of pasta sheet to form individual pieces of filled pasta; the station for preparing the filling comprises a feeder device for feeding the filling to the filling operation station; the feeder device comprises: a feed duct comprising an inlet and an outlet for the filling; a piston operating in the feed duct feeding the filling from the inlet to the outlet; an ultrasound generator provided with an ultrasound emitter applied to the feed duct for transmitting at least one vibration to the feed duct.

### TECHNICAL FIELD

This invention relates to a feeder device for feeding a food product in a machine for making filled pasta and the machine comprising such a device.

In particular, this invention relates to a feeder device for feeding a filling, to which explicit reference will be made without thereby limiting the scope of the invention, in a machine for making filled pasta such as tortellini, tortelloni or ravioli.

Hereinafter in this description reference is made, by way of example and for simplicity, to a device of the above-mentioned type operating in a machine for making filled pasta without thereby limiting the scope of the invention.

### BACKGROUND ART

In prior art machines for making filled pasta at least one strip of pasta sheet is usually fed towards a filling operation station in which suitable portions of filling are wrapped in the pasta strip to form individual pieces of filled pasta.

Machines for making filled pasta comprise a feeder device for feeding the filling to the filling operation station.

The feeder device for feeding the filling comprises, in an example embodiment, a duct, forming a feed cylinder, comprising an inlet for receiving the filling, and an outlet leading to the filling operation station, substantially at the strip of pasta sheet.

Moreover, prior art feeder devices comprise an actuator, for example pneumatic, with a piston or rod inserted in the feed cylinder for pushing out of it the individual portions or doses of filling towards the filling operation station.

One disadvantage of prior art feeder devices for feeding the filling, in particular in the case of semi-liquid, sticky or pasty filling, derives from the fact that at the outlet of the duct aggregates of filling form which remain attached to the duct.

More precisely, the action of the piston causes build-ups of filling on the outlet of the feed cylinder.

Such build-ups remain attached to the duct where, in general, they dry, losing their organoleptic and hygienic properties, making it necessary to stop and clean the entire machine.

Moreover, the dose moved by the piston does not completely reach the filling operation station, leading to uncertainty regarding the quantity of filling actually inserted in each individual piece of filled pasta made.

### DISCLOSURE OF THE INVENTION

In this context, the main technical purpose of this invention is to propose a feeder device for feeding a filling in a machine for making filled pasta, and a machine for making filled pasta which are free of the above-mentioned disadvantages.

One aim of this invention is to propose a feeder device for feeding a filling which allows precise dosing of the filling.

Another aim of this invention is to propose a dosing device for dosing the filling in machines for making filled pasta which does not require regular machine stops for cleaning and maintenance.

The technical purpose indicated and the aims specified are substantially achieved by a feeder device for feeding a food product, in particular filling, according to claim 1, and by a machine for making filled pasta according to claim 5.

### BRIEF DESCRIPTION OF DRAWINGS

Further features and advantages of this invention are more apparent in the description below, with reference to a preferred, non-limiting embodiment of a machine for making filled pasta as illustrated in the accompanying drawings, in which:

FIG. 1 is a schematic side view partly in cross-section, partly in blocks and with some parts cut away for greater clarity, of a machine for making filled pasta comprising a feeder device according to this invention;

FIG. 2 is a schematic side view partly in cross-section, partly in blocks and with some parts cut away for greater clarity and with the feeder device in a second operating configuration, of the machine for making filled pasta of FIG. 1.

### DETAILED DESCRIPTION OF PREFERRED EMBODIMENTS OF THE INVENTION

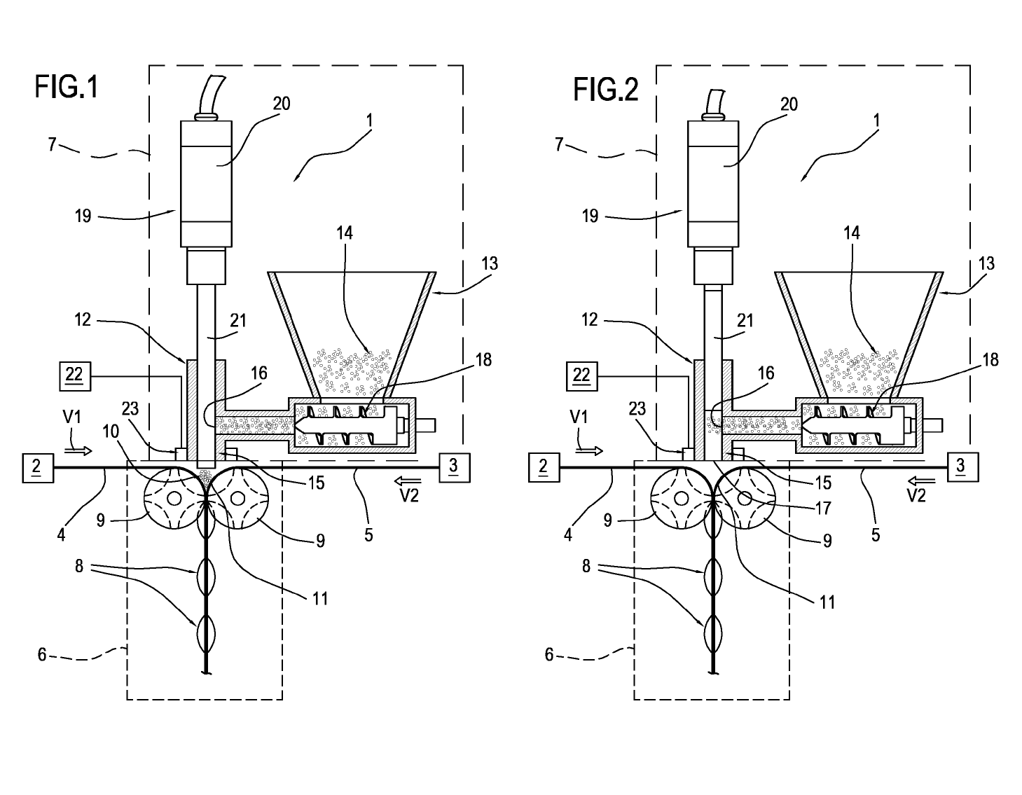

With reference to FIGS. 1 and 2, the numeral 1 denotes in its entirety a machine for making filled pasta, in particular used for making filled pasta of the type consisting of a shell made of pasta sheet in which a filling is inserted, such as tortellini, tortelloni or ravioli.

An example of a machine 1 is described in detail below, limited to the parts necessary for understanding this invention.

In the example embodiment illustrated, the machine 1 comprises a first station and a second station 2, 3 for preparing a respective strip 4, 5 of pasta sheet; each preparation station 2, 3 is schematically illustrated with a corresponding block.

The machine 1 comprises a pasta filling operation station schematically illustrated with a block 6 drawn with a dashed line, in communication with the stations 2 and 3.

The stations 2 and 3 comprise feed system, not illustrated, for moving, respectively, the strip 4 in direction V1 and the strip 5 in direction V2 towards the filling operation station 6.

The machine 1 comprises a station for preparing the filling, schematically illustrated with a corresponding block 7, in communication with the filling operation station 6.

The station 6 comprises a system for forming individual pieces 8 of filled pasta which in the example is schematically illustrated with a pair of wheels 9. The wheels 9 receive the above-mentioned strips 4, 5 and a dose or portion 10 of filling and, in the substantially known way, they form the pieces 8.

In practice, in the filling operation station 6, which is in communication with the stations 2, 3 for preparing the pasta sheet and with the station 7 for preparing the filling, the portions 10 of filling are wrapped in corresponding portions 11 of the strip of pasta sheet to form the individual pieces 8 of filled pasta.

The pieces 8 are then fed one after another, in a known way which is not described, to the machine 1 outfeed.

Looking in more detail at the station 7, it should be noticed that it comprises a feeder device 12 for feeding a food product, in particular the filling, to the filling operation station 6.

According to what is illustrated, the station 7 comprises a container 13, for example a hopper, into which the filling, labelled 14, is supplied.

The feeder device 12 comprises a feed duct 15, comprising an inlet 16 for the filling 14 and an outlet 17.

The inlet 16 is in communication with the container 13 from which it receives the filling 14, for example by means of a screw feeder 18 operating between an outfeed of the container 13 and the inlet 16 of the duct 15.

The feeder device 12 comprises movement means for moving the filling 14 operating inside the duct 15 for feeding the filling 14 from the inlet 16 towards the outlet 17.

In the example illustrated, the means for moving the filling 14 are an actuator 19, for example pneumatic, comprising a jacket 20 and a piston 21 movable between a position near to the jacket 20, illustrated in FIG. 1, and a position distanced from the jacket 20, illustrated in FIG. 2.

It should be noticed that the distanced position corresponds to a position of expulsion of the filling 14 from the duct 15 towards the filling operation station 6.

According to this invention, the feeder device 12 comprises an ultrasound generator, substantially known and schematically illustrated with a corresponding block 22, for generating vibrations, that is to say, low amplitude, high frequency oscillations, in the duct 15.

The ultrasound generator 22 comprises an ultrasound emitter, schematically illustrated with a block 23, which is applied to the duct 15 for transmitting a vibration to it.

The emitter 23 comprises a component which transmits the vibration to the duct 15, normally known as a “sonotrode”.

In a preferred embodiment, the emitter 23, in particular the “sonotrode” is applied to the duct 15 at the outlet 17.

In a preferred embodiment, the emitter 23 is integrated in the duct 15, that is to say, the duct 15 comprises the ultrasound emitter 23.

In the preferred embodiment illustrated, the ultrasound emitter 23 delimits the outlet 17 of the duct 15.

More precisely, the end part of the duct 15 in which the outlet 15 is located is formed by the emitter 23, in particular by the “sonotrode”.

In use, the ultrasound generator 22 triggers suitable vibrations at the outlet 17 of the duct 15, substantially preventing the filling from remaining attached to the duct 15.

The ultrasound waves generated by the generator 22 trigger the vibrations, guaranteeing the cleanness of the machine and precise dosing of the filling in the individual pieces of pasta.

Making the duct 15 directly integrated with the emitter 23 makes the machine particularly compact.

1. A feeder device for feeding a food product in a machine for making filled pasta, said feeder device comprising
a feed duct comprising an inlet and an outlet for the food product, said feeder device comprising
movement means operating in the feed duct for feeding the food product from the inlet to the outlet, and
an ultrasound generator provided with an ultrasound emitter applied to the duct for transmitting at least one vibration to the feed duct.

2. The feeder device according to claim 1, wherein the ultrasound emitter is applied to the feed duct at the outlet.

3. The feeder device according to claim 1, wherein the feed duct comprises the ultrasound emitter.

4. The feeder device according to claim 1, wherein the ultrasound emitter at least partly delimits the outlet of the feed duct.

5. A machine for making filled pasta comprising at least one station for preparing a strip of pasta sheet;
a station for preparing a filling;
a filling operation station in communication with the station for preparing a strip of pasta sheet and with the station for preparing a filling, in which portions of filling are wrapped in corresponding portions of the strip of pasta sheet to form individual pieces of filled pasta, said station for preparing a filling comprising a feeder device for a food product for feeding said filling to the filling operation station, wherein the feeder device is according to claim 1.
